(19) United States
(12) Patent Application Publication
(10) Pub. No.: US 2010/0259490 A1
(43) Pub. Date: Oct. 14, 2010

(54) Touch Control Electrophoretic Display Module, and Manufacturing Method and Touch Sensing Method for the same

(76) Inventor: Cheng-Hao LEE, Hsinchu (TW)

Correspondence Address: LanWay IPR Services, P.O. Box 220746, Chantilly, VA, 20153, US

(21) Appl. No.: 12/487,721

(22) Filed: Jun. 19, 2009

(30) Foreign Application Priority Data
Apr. 8, 2009 (TW) 098111741

(51) Int. Cl. G06F 3/041

(52) U.S. Cl. 345/173; 345/107

(57) ABSTRACT

In a touch control electrophoretic display module, and a manufacturing method and a touch sensing method for the same, the touch control electrophoretic display module includes a flexible electrophoretic display apparatus and a pressure sensing apparatus. The flexible electrophoretic display apparatus has a first surface and a second surface, wherein the first surface has a display area used for displaying needed images. The pressure sensing apparatus is disposed on the second surface. Furthermore, the pressure sensing apparatus is used for sensing a pressure inputted in the display area through the body of the flexible electrophoretic display apparatus, so as to calculate the input coordinates of the pressure input.

This application claims the priority benefit of Taiwan application serial no. 098111741, filed on Apr. 8, 2009.

### BACKGROUND

1. Technical Field

The present invention generally relates to the field of a display and, more particularly, to a touch control electrophoretic display module, and a manufacturing method and a touch sensing method for the touch control electrophoretic display module.

2. Description of the Related Art

FIG. 1 shows a conventional touch control electrophoretic display module. Referring to FIG. 1, the touch control electrophoretic display module 100 comprises a pressure sensing apparatus 102 and an electrophoretic display apparatus 104. The pressure sensing apparatus 102 is designed as a transparent sheet or at least the overlapping portion of the pressure sensing apparatus 102 with a displaying area 110 of the electrophoretic display apparatus 104 is transparent, such that users could watch images displayed by the displaying area 110. The electrophoretic display apparatus 104 has a first surface 106 and a second surface 108, wherein the first surface 106 has the aforementioned displaying area 110. The pressure sensing apparatus 102 is used for sensing a pressure input from a user (e.g., the pressing from the user), so as to calculate the input coordinates of the pressure input.

A disadvantage of the touch control electrophoretic display module 100 is that the transmittance and the contrast of the touch control electrophoretic display module 100 are poor. The reason why the touch control electrophoretic display module 100 has the disadvantage is described as follows. The electrophoretic display apparatus 104 is a reflection type display apparatus, which displays needed images by reflecting the environment illumination. Nevertheless, the pressure sensing apparatus 102 of the touch control electrophoretic display module 100 is disposed on the first surface 106 of the electrophoretic display apparatus 104, and the first surface 106 is a surface having the aforementioned displaying area 110, such that the transmittance and the contrast of the touch control electrophoretic display module 100 are decreased.

Generally speaking, the downstream manufacturers purchase the electrophoretic display apparatus and the pressure sensing apparatus for assembly. Nevertheless, according to the arrangement that the pressure sensing apparatus 102 is disposed on the first surface 106 of the electrophoretic display apparatus 104, it is more difficult when the downstream manufacturers assemble the touch control electrophoretic display module 100. Further, the production costs of the downstream member firms will also be increased.

### BRIEF SUMMARY

The present invention relates to a touch control electrophoretic display module, so that the transmittance and the contrast of the present touch control electrophoretic display module are higher than that of the conventional one.

The present invention further relates to a manufacturing method for a touch control electrophoretic display module, so that the transmittance and the contrast of the present touch control electrophoretic display module manufactured in accordance with the manufacturing method are higher than that of the conventional one. Further, the downstream manufacturers do not need to worry about the assembly of the touch control electrophoretic display module any more, and the production costs of the downstream member firms will also be reduced.

The present invention further relates to a touch sensing method for a touch control electrophoretic display module, which is adapted for the aforementioned touch control electrophoretic display module.

A touch control electrophoretic display module provided by the invention comprises a flexible electrophoretic display apparatus and a pressure sensing apparatus. The flexible electrophoretic display apparatus has a first surface and a second surface, wherein the first surface has a displaying area used for displaying needed images. The pressure sensing apparatus is disposed on the second surface. The pressure sensing apparatus is used for sensing a pressure inputted in the display area through the body of the flexible electrophoretic display apparatus, so as to calculate the input coordinates of the pressure input.

A manufacturing method for a touch control electrophoretic display module provided by the present invention comprises: providing a flexible electrophoretic display apparatus and a pressure sensing apparatus, the flexible electrophoretic display apparatus having a first surface and a second surface, the first surface having a displaying area, the displaying area being used for displaying needed images; and attaching the pressure sensing apparatus on the second surface.

In a touch sensing method for a touch control electrophoretic display module provided by the present invention, the touch control electrophoretic display module comprises a flexible electrophoretic display apparatus and a pressure sensing apparatus. The flexible electrophoretic display apparatus has a first surface and a second surface, wherein the first surface has a displaying area used for displaying needed images. The pressure sensing apparatus is disposed on the second surface. The touch sensing method comprises: employing the pressure sensing apparatus to sense a pressure inputted in the display area through the body of the flexible electrophoretic display apparatus; and calculating the input coordinates of the pressure input.

In one embodiment, the pressure sensing apparatus is attached on the second surface directly.

In another embodiment, the pressure sensing apparatus is implemented by a pressure-sensitive touch panel or a resistive touch panel, wherein the pressure-sensitive touch panel comprises a plurality of force sensors.

In the present invention, the pressure sensing apparatus is disposed on the second surface of the flexible electrophoretic display apparatus, so as to form a touch control electrophoretic display module. Since the flexible electrophoretic display apparatus is not as hard as glass, the flexible electrophoretic display apparatus could be pressed, and the flexible characteristic of the flexible electrophoretic display apparatus could be utilized, such that a pressure input from a user could be transmitted to the pressure sensing apparatus, and therefore the touch sensing function could be achieved. In addition, the pressure sensing apparatus is not disposed on the first surface having the displaying area but disposed on the second surface of the flexible electrophoretic display apparatus, such that the transmittance and the contrast of the touch control electrophoretic display module will not be decreased.

Furthermore, if an upstream manufacturer directly assembles the flexible electrophoretic display apparatus and the pressure sensing apparatus to form the touch control electrophoretic display module after manufacturing the flexible electrophoretic display apparatus, thus the downstream manufacturers do not need to worry about the assembly of the touch control electrophoretic display module any more, and the production costs of the downstream member firms will also be reduced.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a conventional touch control electrophoretic display module.

FIG. 2 shows a touch control electrophoretic display module in accordance with an embodiment of the present invention.

FIG. 3 shows a schematic view of a pressure-sensitive touch panel.

FIG. 4 shows a flow chart of a manufacturing method in accordance with an embodiment of the present invention, which is adapted for a touch control electrophoretic display module.

FIG. 5 shows a flow chart of a touch sensing method in accordance with an embodiment of the present invention, which is adapted for a touch control electrophoretic display module.

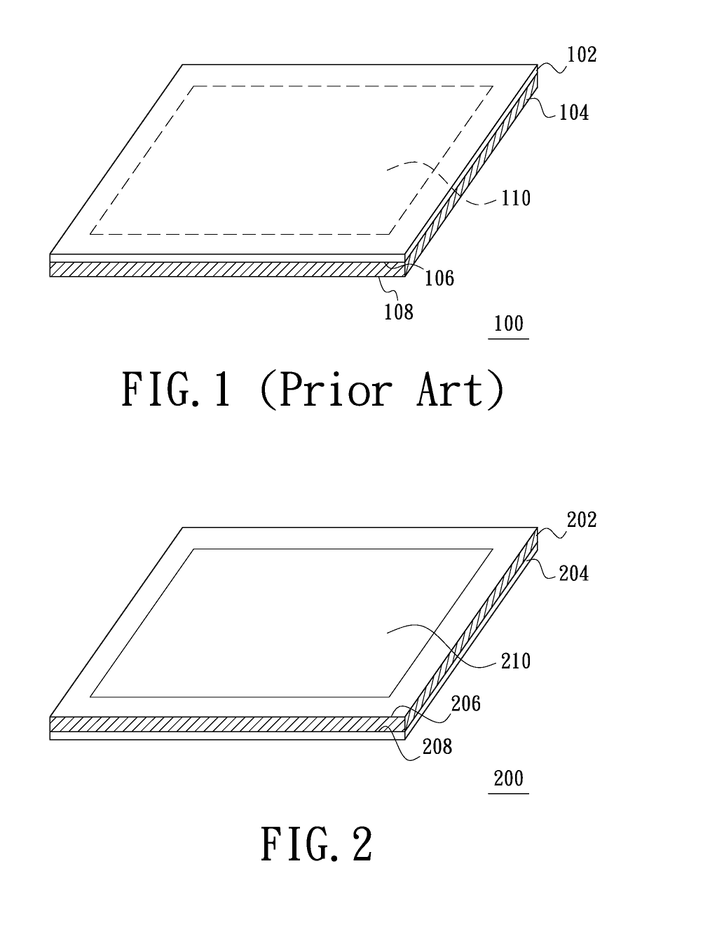

### DETAILED DESCRIPTION

FIG. 2 shows a touch control electrophoretic display module in accordance with an embodiment of the present invention. Referring to FIG. 2, the touch control electrophoretic display module 200 comprises a flexible electrophoretic display apparatus 202 and a pressure sensing apparatus 204. The flexible electrophoretic display apparatus 202 has a first surface 206 and a second surface 208, wherein the first surface 206 has a displaying area 210 used for displaying needed images. The pressure sensing apparatus 204 is disposed on the second surface 208. The pressure sensing apparatus 204 is used for sensing a pressure (e.g., the pressing from a user) inputted in the display area 210 through the body of the flexible electrophoretic display apparatus 202, so as to calculate the input coordinates of the pressure input.

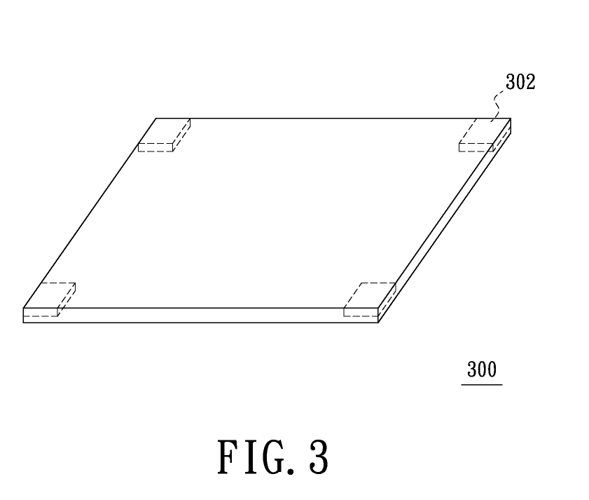

In this embodiment, the pressure sensing apparatus 204 is attached on the second surface 208 directly. However, this is not a limitation of the present invention. In addition, the pressure sensing apparatus 204 could be implemented by a pressure-sensitive touch panel or a resistive touch panel. FIG. 3 shows a schematic view of a pressure-sensitive touch panel. Referring to FIG. 3, the pressure-sensitive touch panel 300 comprises four force sensors 302, and the force sensors are used for sensing the aforementioned pressure input. It is understood that the number of the force sensors adopted in the pressure-sensitive touch panel 300 could be any natural number, and the number is not limited in four.

From the teachings of the abovementioned embodiments, since the flexible electrophoretic display apparatus 202 is not as hard as glass, the flexible electrophoretic display apparatus 202 could be pressed, and the flexible characteristic of the flexible electrophoretic display apparatus 202 could be utilized, such that a pressure input from a user could be transmitted to the pressure sensing apparatus 204, and therefore the touch sensing function could be achieved. In addition, the pressure sensing apparatus 204 is not disposed on the first surface 206 having the displaying area 210 but disposed on the second surface 208 of the flexible electrophoretic display apparatus 202, such that the transmittance and the contrast of the touch control electrophoretic display module 200 will not be decreased.

It is noted that in a high level design, the pressure sensing apparatus 204 of the touch control electrophoretic display module 200 could further perform a hand gesture recognition through the body of the flexible electrophoretic display apparatus 202. Furthermore, the pressure sensing apparatus 204 could further perform an acceleration detection according to the movement of the input position of the pressure input through the body of the flexible electrophoretic display apparatus 202. In other words, as long as the input position of the pressure input from the user is moved from an initial coordinates to a target coordinates, and the input coordinates between the initial coordinates and the target coordinates are continuous, thus the touch control electrophoretic display module 200 could perform an acceleration detection according to the movement of the input position of the pressure input.

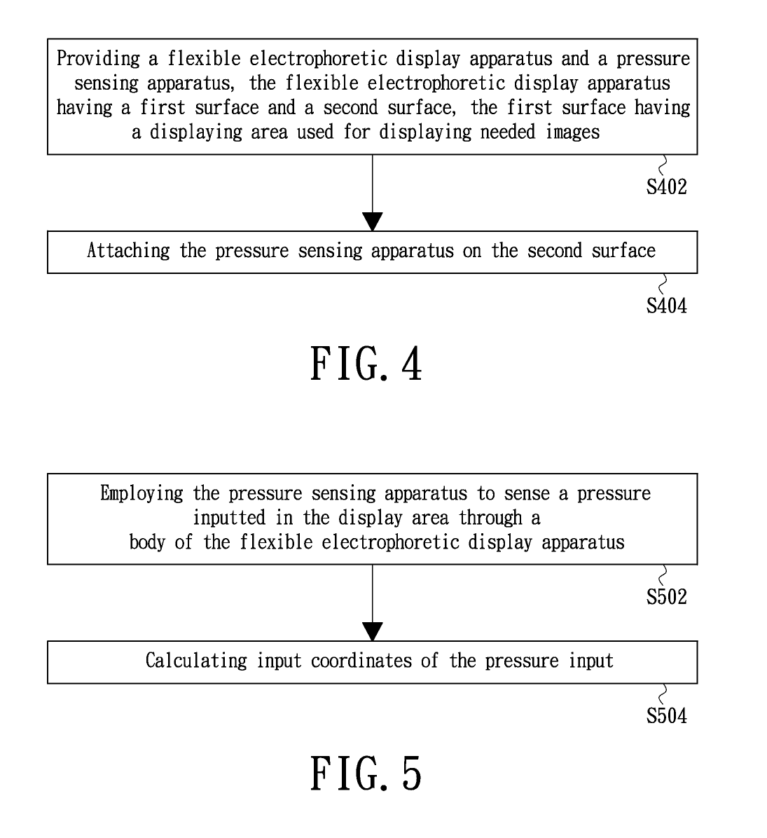

FIG. 4 shows a flow chart of a manufacturing method in accordance with an embodiment of the present invention, which is adapted for a touch control electrophoretic display module. Referring to FIG. 4, the manufacturing method comprises: providing a flexible electrophoretic display apparatus and a pressure sensing apparatus, the flexible electrophoretic display apparatus having a first surface and a second surface, the first surface having a displaying area being used for displaying needed images (step S402); and attaching the pressure sensing apparatus on the second surface (step S404).

Certainly, in the manufacturing method, the pressure sensing apparatus could be attached on the second surface directly. Furthermore, the pressure sensing apparatus could be implemented by a pressure-sensitive touch panel or a resistive touch panel, wherein the pressure-sensitive touch panel comprises a plurality of force sensors.

It is noted that if an upstream manufacturer directly assembles the flexible electrophoretic display apparatus and the pressure sensing apparatus to form the touch control electrophoretic display module after manufacturing the flexible electrophoretic display apparatus, thus the downstream manufacturers do no need to worry about the assembly of the touch control electrophoretic display module any more, and the production costs of the downstream member firms will also be reduced.

In addition, from the aforementioned operation manners of the touch control electrophoretic display module 200, a touch sensing method could be achieved, as shown in FIG. 5. FIG. 5 shows a flow chart of a touch sensing method in accordance with an embodiment of the present invention, which is adapted for a touch control electrophoretic display module. The touch control electrophoretic display module comprises a flexible electrophoretic display apparatus and a pressure sensing apparatus. The flexible electrophoretic display apparatus has a first surface and a second surface, wherein the first surface has a displaying area used for displaying needed images. The pressure sensing apparatus is disposed on the second surface. The touch sensing method comprises: employing the pressure sensing apparatus to sense a pressure inputted in the display area through the body of the flexible electrophoretic display apparatus (step S502); and calculating the input coordinates of the pressure input (step S504).

Certainly, the touch sensing method could further comprises employing the pressure sensing apparatus to perform a hand gesture recognition through the body of the flexible electrophoretic display apparatus. Furthermore, the touch sensing method could further comprises employing the pressure sensing apparatus to perform an acceleration detection according to the movement of the input position of the pressure input through the body of the flexible electrophoretic display apparatus.

To sum up, in the present invention, the pressure sensing apparatus is disposed on the second surface of the flexible electrophoretic display apparatus, so as to form a touch control electrophoretic display module. Since the flexible electrophoretic display apparatus is not as hard as glass, the flexible electrophoretic display apparatus could be pressed, and the flexible characteristic of the flexible electrophoretic display apparatus could be utilized, such that a pressure input from a user could be transmitted to the pressure sensing apparatus, and therefore the touch sensing function could be achieved. In addition, the pressure sensing apparatus is not disposed on the first surface having the displaying area but disposed on the second surface of the flexible electrophoretic display apparatus, such that the transmittance and the contrast of the touch control electrophoretic display module will not be decreased.

Furthermore, if an upstream manufacturer directly assembles the flexible electrophoretic display apparatus and the pressure sensing apparatus to form the touch control electrophoretic display module after manufacturing the flexible electrophoretic display apparatus, thus the downstream manufacturers do not need to worry about the assembly of the touch control electrophoretic display module any more, and the production costs of the downstream member firms will also be decreased.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A touch control electrophoretic display module, comprising:
a flexible electrophoretic display apparatus, having a first surface and a second surface, wherein the first surface has a displaying area used for displaying needed images; and
a pressure sensing apparatus, disposed on the second surface, wherein the pressure sensing apparatus is used for sensing a pressure inputted in the display area through a body of the flexible electrophoretic display apparatus, so as to calculate input coordinates of the pressure input.

2. The touch control electrophoretic display module as claimed in claim 1, wherein the pressure sensing apparatus is attached on the second surface directly.

3. The touch control electrophoretic display module as claimed in claim 1, wherein the pressure sensing apparatus is implemented by a pressure-sensitive touch panel or a resistive touch panel, the pressure-sensitive touch panel comprises a plurality of force sensors.

4. The touch control electrophoretic display module as claimed in claim 1, wherein the pressure sensing apparatus further performs a hand gesture recognition through the body of the flexible electrophoretic display apparatus.

5. The touch control electrophoretic display module as claimed in claim 1, wherein the pressure sensing apparatus further performs an acceleration detection according to a movement of an input position of the pressure input through the body of the flexible electrophoretic display apparatus.

6. A manufacturing method for a touch control electrophoretic display module, comprising:
providing a flexible electrophoretic display apparatus and a pressure sensing apparatus, the flexible electrophoretic display apparatus having a first surface and a second surface, the first surface having a displaying area used for displaying needed images; and
attaching the pressure sensing apparatus on the second surface.

7. The manufacturing method as claimed in claim 6, wherein the pressure sensing apparatus is attached on the second surface directly.

8. The manufacturing method as claimed in claim 6, wherein the pressure sensing apparatus is implemented by a pressure-sensitive touch panel or a resistive touch panel, the pressure-sensitive touch panel comprises a plurality of force sensors.

9. A touch sensing method for a touch control electrophoretic display module, wherein the touch control electrophoretic display module comprises a flexible electrophoretic display apparatus and a pressure sensing apparatus, the flexible electrophoretic display apparatus has a first surface and a second surface, the first surface has a displaying area used for displaying needed images, and the pressure sensing apparatus is disposed on the second surface, the method comprises:
employing the pressure sensing apparatus to sense a pressure inputted in the display area through a body of the flexible electrophoretic display apparatus; and
calculating input coordinates of the pressure input.

10. The touch sensing method as claimed in claim 9, further comprising:
employing the pressure sensing apparatus to perform a hand gesture recognition through the body of the flexible electrophoretic display apparatus.

11. The touch sensing method as claimed in claim 9, further comprising:
employing the pressure sensing apparatus to perform an acceleration detection according to a movement of the input position of the pressure input through the body of the flexible electrophoretic display apparatus.
